(19) United States
(12) Patent Application Publication
(10) Pub. No.: US 2007/0236131 A1
(43) Pub. Date: Oct. 11, 2007

(54) IMAGE DISPLAY APPARATUS

(76) Inventors: Masataka TSUNEMI, Isesaki-shi (JP); Yuuji Haraguchi, Hiratsuka-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/763,494

(22) Filed: Jun. 15, 2007

Related U.S. Application Data
(63) Continuation of application No. PCT/JP05/22357, filed on Dec. 6, 2005.

(30) Foreign Application Priority Data
Dec. 15, 2004 (JP) 2004-363464

(51) Int. Cl. H01J 31/12

(52) U.S. Cl. 313/495; 313/496

(57) ABSTRACT

An image display apparatus comprises a vacuum envelope including a front substrate in which a fluorescent surface is formed, and a back surface which is arranged opposite to the front substrate with a gap therebetween and in which a plurality of electron emission elements for exciting the fluorescent surface are provided, an interior of the vacuum envelope being kept vacuum, a metalback including a plurality of split portions that superpose the fluorescent surface, a plurality of connection resistors electrically connected to the split portions, respectively, a common electrode arranged outside the metalback and electrically connected to the metalback via the connection resistors, a power supply unit configured to supply electric charges to the common electrode, and a limiting resistor connected between the common electrode and the power supply unit, to limit the supply of electric charges from the power supply unit to the common electrode.

### CROSS-REFERENCE TO RELATED APPLICATIONS

This is a Continuation Application of PCT application No. PCT/JP2005/022357, filed Dec. 6, 2005, which was published under PCT Article 21(2) in Japanese.

This application is based upon and claims the benefit of priority from the prior Japanese Patent Application No. 2004-363464, filed Dec. 15, 2004, the entire contents of which are incorporated herein by reference.

### BACKGROUND OF THE INVENTION

1. Field of the Invention

The present invention relate to an image display apparatus and, more particularly, to an image display apparatus comprising a split metalback.

2. Description of the Related Art

Recently, as an image display apparatus, a flat-type image display apparatus having a number of electron emission elements aligned and having a fluorescent plane arranged opposite to the electron emission elements has been developed. There are various kinds of electron emission elements and each kind of them basically employs electron emission. For example, as thin image display apparatuses, a field emission display (hereinafter called FED) urging a fluorescent member to emit light by electron beams emitted from field emission type electron emission elements, and a surface-conduction electron-emitter display (hereinafter called SED) urging a fluorescent member to emit light by electron beams of surface-conduction electron-emitters are known.

For example, the SED comprises a front substrate and a back substrate which are arranged opposite to each other with a gap therebetween. A vacuum envelope is formed by bonding peripheral portions of these substrates via rectangular frame-shaped side wall. An interior of the vacuum envelope is maintained in a high vacuum in which the degree of vacuum is below approximately 10⁻⁴ Pa. In addition, to bear the atmospheric pressure load applied to the back substrate and the front substrate, a plurality of spacers are arranged between the substrates.

A fluorescent surface including red, blue and green fluorescent layers is formed on an inner surface of the front substrate, and a number of electron emission elements emitting electrons and exciting the fluorescent member to emit light are provided on an inner side of the back surface. In addition, a number of scanning lines and signal lines are formed in a matrix and connected to the electron emission elements, respectively.

An anode voltage is applied to the fluorescent surface, the electron beams emitted from the electron emission elements are accelerated by the anode voltage and collides with the fluorescent surface, and the fluorescent member thereby emits light to display an image. In such an SED, a gap between the front substrate and the back substrate can be set at not more than a few mm, and weight reduction and thinning can be achieved as compared with a cathode ray tube (CRT) currently employed as a display of TV and PC.

To obtain practical display characteristics in the SED having the above structure, it is necessary to use a plurality of fluorescent layers similar to those of the general CRT and further use a fluorescent surface in which an aluminum thin film called metalback is formed on the fluorescent layers. In this case, it is desirable that the anode voltage applied to the fluorescent surface should be at least a few kV and, if possible, more than 10 kV.

However, the gap between the front substrate and the back substrate cannot be made so great from the viewpoint of the resolution, characteristics of the spacer, and the like, and needs to be set at approximately 1 to 2 mm. For this reason, formation of a strong electric field in a small gap between the front substrate and the back substrate cannot be avoided in the SED and discharging (dielectric breakdown) between both the substrates turns into a problem.

When discharging occurs, a current of more than 100A may often flow instantaneously between the substrates, and may cause breakage or deterioration of the electron emission elements and the fluorescent surface and, moreover, breakage of the driving circuit. All of them are called damage caused by the discharging. The discharging which causes defectiveness is not permissible for products. Therefore, to commercialize the SED, it has to be formed such that the damage caused by the discharging does not occur for a long period. However, it is very difficult to completely restrict the discharging for a long period.

Thus, a measure to limit the scale of the discharging such that the influence to the electron emission elements can be neglected at the occurrence of the discharging becomes important. As for the measure, for example, JP-A No. 2004-152494 discloses a technique of forming an SED by splitting the metalback into a plurality of portions. The metalback comprises a plurality of split portions. Furthermore, a common electrode and a resistor are formed on the front substrate, and the common electrode and the split portions are connected via the resistor. A high voltage supply terminal is formed at a part of the common electrode and the above anode voltage is applied to the high voltage supply terminal.

When an image is displayed on the SED in which the metalback is formed as described above, the discharging may occur between the common electrode and the split portions due to the occurrence of the discharging between the front substrate and the back substrate. The discharging causes further discharging between the common electrode and the other split portions, and stripe-shaped damage thereby occurs. In this case, breakage or deterioration of the electron emission elements and the fluorescent surface and, moreover, breakage of the driving circuit are caused and the display quality is degraded.

### BRIEF SUMMARY OF THE INVENTION

The present invention has been accomplished in the above point. The object of the present invention is to provide an image display apparatus which restricts occurrence of the discharging and which is excellent in display quality.

According to an aspect of the present invention, there is provided an image display apparatus comprising:

a vacuum envelope including a front substrate in which a fluorescent surface is formed, and a back surface which is arranged opposite to the front substrate with a gap therebetween and in which a plurality of electron emission elements for exciting the fluorescent surface are provided, an interior of the vacuum envelope being kept vacuum;

a metalback including a plurality of split portions that superpose the fluorescent surface;

a plurality of connection resistors electrically connected to the split portions, respectively;

a common electrode arranged outside the metalback and electrically connected to the metalback via the connection resistors;

a power supply unit configured to supply electric charges to the common electrode; and

a limiting resistor connected between the common electrode and the power supply unit, to limit the supply of electric charges from the power supply unit to the common electrode.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing a SED according to an embodiment of the present invention;

FIG. 2 is a cross-sectional view showing the SED as seen along line II-II of FIG. 1;

FIG. 3 is an enlarged view showing a front substrate shown in FIG. 2;

FIG. 4 is a schematically plan view showing the front substrate of the SED;

FIG. 5 is a graph showing variation in voltage of each of stripe portions in a case where discharging occurs;

FIG. 6 is a graph showing variation in voltage of each of stripe portions in a case where discharging occurs at an arbitrary stripe portion of a practical metalback;

FIG. 7 is a schematically plan view showing a modified example of the front substrate of the SED; and

FIG. 8 is a schematically plan view showing another modified example of the front substrate of the SED.

### DETAILED DESCRIPTION OF THE INVENTION

Embodiments of applying an image display apparatus of the present invention to an SED will be explained below with reference to the accompanying drawings.

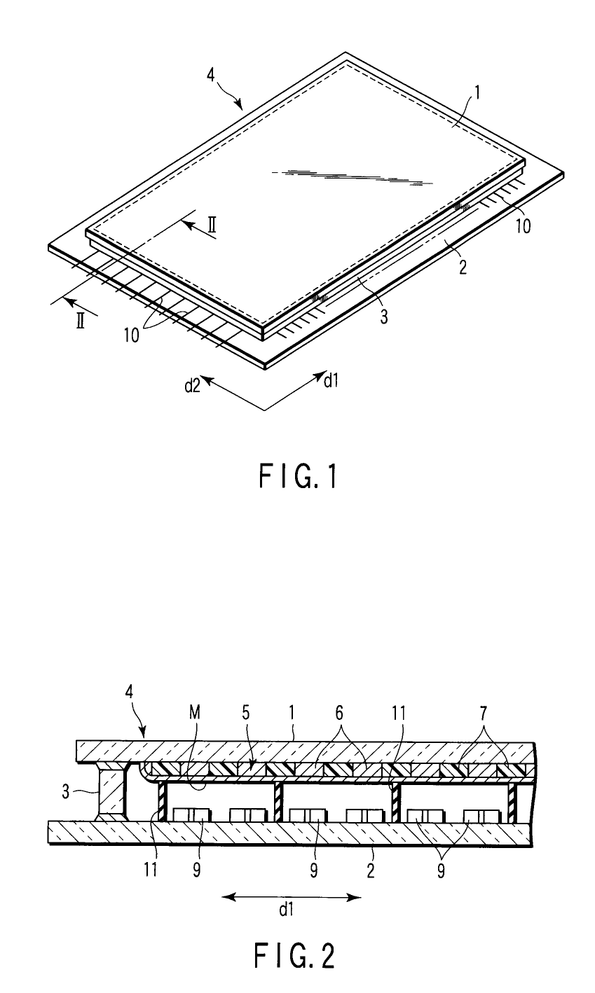

As shown in FIG. 1 to FIG. 3, the SED comprises a front substrate 1 and a back substrate 2 each formed of a rectangular glass, and the substrates are arranged opposite to each other with a gap of 1 to 2 mm. The front substrate 1 and the back substrate 2 have peripheral portions bonded via a rectangular frame-shaped side wall 3 to form a flat, rectangular vacuum envelope 4 having an interior maintained in a high vacuum in which the degree of vacuum is below approximately 10⁻⁴ Pa.

A fluorescent screen 5 functioning as a fluorescent surface is formed on an inner surface of the front substrate 1. The fluorescent screen 5 comprises a plurality of stripe-shaped fluorescent layers 6 that emit light beams of red (R), green (G) and blue (B), and that extend along a first direction d1 and are arranged parallel with predetermined intervals in a second direction d2 orthogonal with the first direction, and shield layers 7 provided in spaces of the fluorescent layers 6. A metalback M functioning as an anode electrode is formed on the fluorescent screen 5.

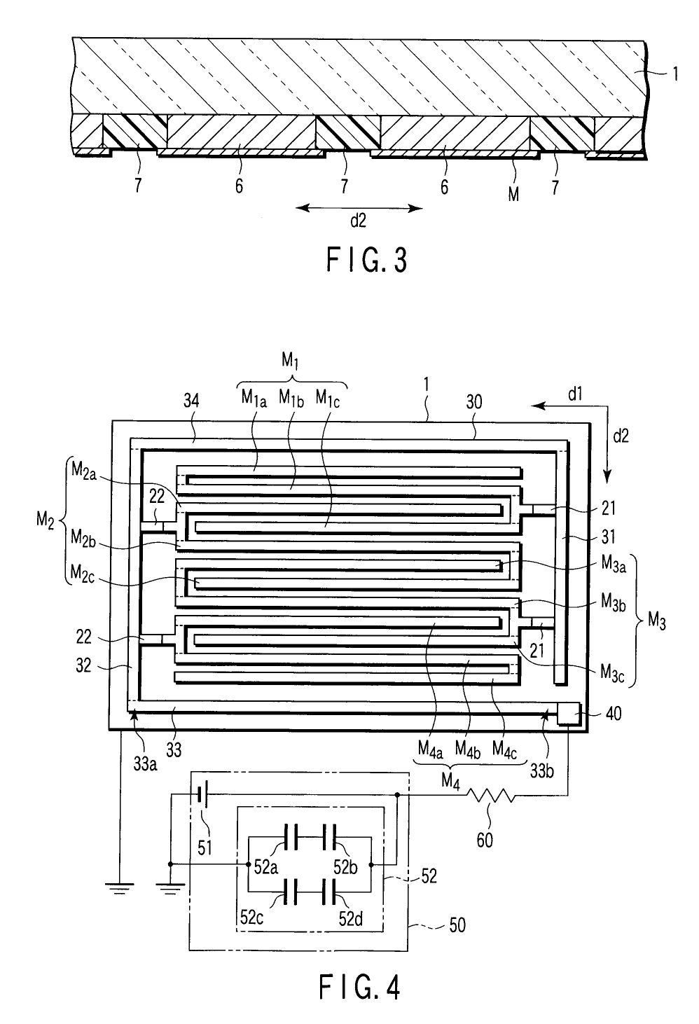

As shown in FIG. 3 and FIG. 4, the metalback M have a plurality of split portions M₁ to M₄ aligned in the second direction d2. For schematic explanation of the metalback M, the metalback has four split portions. The split portions M₁ to M₄ are extended in the first direction d1 and aligned parallel with the second direction d2 with predetermined intervals, and have stripe portions M₁ₐ to M_{1c}, M₂ₐ to M_{2c}, M₃ₐ to M_{3c}, and M₄ₐ to M_{4c}, electrically connected mutually to each other.

The stripe portions of the adjacent split portions are provided alternately in the second direction d2. In this embodiment, the split portions M₁ to M₄ are formed substantially in an S letter. The stripe portions M₁ₐ to M_{1c}, M₂ₐ to M_{2c}, M₃ₐ to M_{3c}, and M₄ₐ to M_{4c} are formed to superpose the fluorescent layers 6.

A number of electron emission elements 9 emitting electron beams to excite the fluorescent layers 6 of the fluorescent screen 5 are provided on an inner surface of the back substrate 2. The electron emission elements 9 are aligned in a plurality of columns and a plurality of rows, in response to respective pixels. Each of the electron emission elements 9 is formed by an electron emitting unit, a pair of element electrodes that apply the voltage to the electron emitting unit, and the like. On the inner surface of the back substrate 2, a number of wirings 10 supplying electric potentials to the electron emission elements 9 are provided in matrix and end portions of the wirings 10 are extracted to a peripheral portion of the vacuum envelope 4. A number of spacers 11 shaped in plate or column are arranged between the front substrate 1 and the back substrate 2, to bear the atmospheric pressure load.

Next, the front substrate 1 is described in detail.

As shown in FIG. 4, for example, a plurality of first connection resistors 21 and a plurality of second connection resistors 22 as a plurality of connection resistors, a common electrode 30, and a high-voltage supply terminal 40 are formed on the inner surface of the front substrate 1. In the present embodiment, the first connection resistors 21 make electric one-on-one connection with the split portions M₁ and M₃, and the second connection resistors 22 make electric one-on-one connection with the split portions M₂ and M₄.

The common electrode 30 is formed in a substantially rectangular shape and arranged outside the metalback M. In the common electrode 30, a pair of first electrode 31 and second electrode 32, a third electrode 33 and a fourth electrode 34 are formed integrally.

The first electrode 31 and the second electrode 32 are provided opposite to each other while sandwiching the metalback in the first direction d1, extended in the second direction d2, and electrically connected to a plurality of split portions M₁ to M₄ via the first connection resistors 21 or the second connection resistors 22. In the present embodiment, the first electrode 31 is electrically connected to the split portions M₁ and M₃ via the first connection resistors 21, and the second electrode 32 is electrically connected to the split portions M₂ and M₄ via the second connection resistors 22.

The third electrode 33 is extended in the first direction d1, outside the metalback M. An end 33a of the third electrode 33 is electrically connected to the second electrode 32 and the other end 33b thereof is spaced apart from the first electrode 31. The fourth electrode 34 is provided opposite to the third electrode 33 to sandwich the metalback M in the second direction d2, and is extended in the first direction d1. The fourth electrode 34 is electrically connected to the first electrode 31 and the second electrode 32.

The high-voltage supply terminal 40 is spaced apart from the first electrode 31, formed at the other end 33b of the third electrode 33, and electrically connected to the common electrode 30. In the present embodiment, the common electrode 30 and the high-voltage supply terminal 40 are integrally formed by printing silver as a conductive material.

In addition, the SED comprises a power supply unit 50 which supplies electric charges to the high-voltage supply terminal 40, and a limiting resistor 60 which is connected between the high-voltage supply terminal and the power supply unit to limit the supply of the electric charges from the power supply unit to the high-voltage supply terminal. In the present embodiment, a resistance value of the limiting resistor 60 is 10 kΩ.

The power supply unit 50 comprises a power supply 51, and a capacitance unit 52 which is electrically connected to an anode of the power supply unit and the limiting resistor 60. The capacitance unit 52 includes, for example, capacitors 52a, 52b, 52c and 52d. A cathode of the power supply 51 and the front substrate 1 are grounded.

When an image is displayed in the SED having the above structure, the power supply 51 outputs anode voltage Va as a drive voltage. The output anode voltage Va is thereby stored in the capacitance unit 52 and applied from the capacitance unit to the high-voltage supply terminal 40 via the limiting resistor 60. The electric charges are thereby supplied to the high-voltage supply terminal 40. The electric charges are also supplied to the split portions Ma to Md via the common electrode 30, and the first connection resistors 21 or the second connection resistors 22.

In the present embodiment, the anode voltage Va is 10 kV. For this reason, the supply of electric charges to the high-voltage supply terminal 40 is restricted by the limiting resistor 60, a potential difference necessary for high-brightness display is generated between the front substrate 1 and the back substrate 2. The electron beams emitted from the electron emission elements 9 are accelerated in accordance with the potential difference between the substrates and are made to collide with the fluorescent screen 5. The corresponding fluorescent layers 6 are thereby excited to emit light and display color images.

Next, a case where the discharging occurs between the front substrate 1 and the back substrate 2 is described.

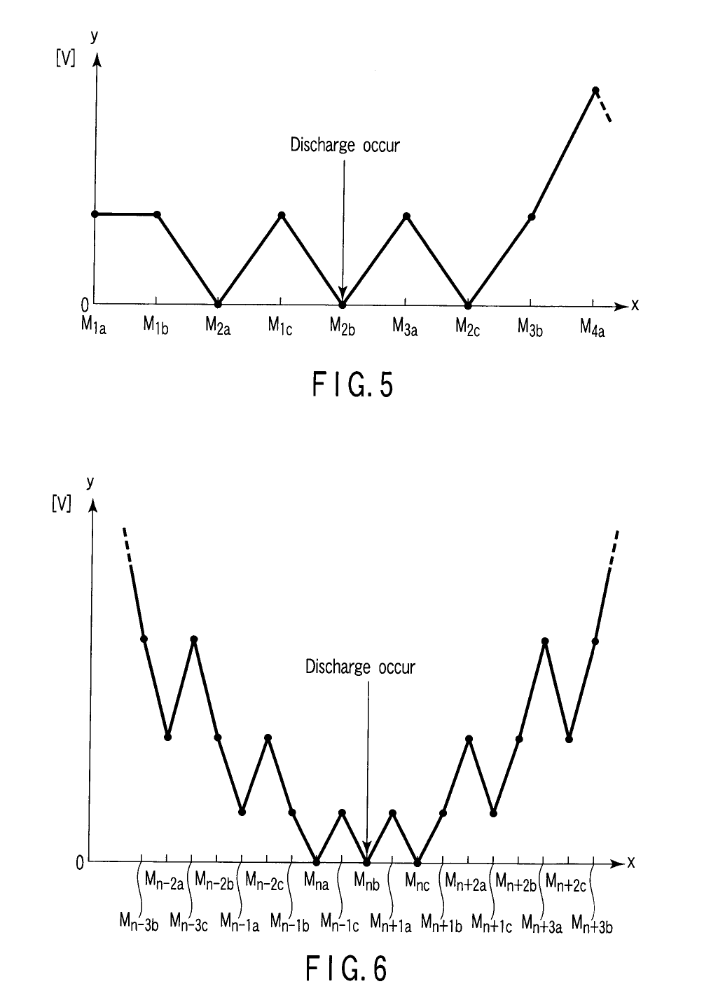

As shown in FIG. 4 and FIG. 5, for example, the discharging occurs between the stripe portion M_{2b} and the back substrate 2. In FIG. 5, x axis represents the stripe portions aligned in the second direction d2 and y axis represents a voltage value of each stripe portion. When the discharging occurs, the voltage of the stripe portion M_{2b} radically drops to 0V. The potential difference is made between the stripe portion M_{2b} and the common electrode 30 and, then, the discharging occurs between the stripe portion M_{2b} and the common electrode 30. A stripe-shaped damage is thereby caused along the stripe portion M_{2b} inside the vacuum envelope 4. When the stripe portion M_{2b} is at 0V, the stripe portion M₂ₐ and the stripe portion M_{2c} are also at 0V, and the discharging also occurs between the stripe portion M₂ₐ and the stripe portion M_{2c}, and the common electrode 30. Then, a stripe-shaped damage is also caused along the stripe portion M₂ₐ and the stripe portion M_{2c}, inside the vacuum envelope 4.

In the above case, the power supply unit 50 continues supplying electric charges to the common electrode 30, but the supply of the electric charges to the common electrode is limited by the limiting resistor 60. For this reason, at the common electrode 30, the voltage at the discharging drops to some extent from the voltage before discharging.

In addition, the voltages of the stripe portion M_{1c} and stripe portion M₃ₐ do not drop to 0V, but drop to approximately 0V due to small intervals of stripe portion M_{2b}—stripe portion M_{1c} and stripe portion M_{2b}—stripe portion M₃ₐ. Simultaneously with the voltages of stripe portion M_{1c} and stripe portion M_{c1}, the voltage of stripe portion M_{3c} also drops to approximately 0V, besides the voltages of the stripe portions M₁ₐ, M_{1b} and M_{3b}. In the above case, the voltages of stripe portions M_{4b} and M_{4c} drop, besides the voltage of stripe portion M₄ₐ, due to small intervals of stripe portion M_{3b}—stripe portion M₄ₐ, but are kept higher than the voltage of the stripe portion M_{3b}. It can be understood from the above matters that at the split portion farther from the split portion M₂ including the stripe portion M_{2b}, the voltage value is kept higher.

FIG. 6 shows voltages of stripe portions M₁ₐ, Mₙₐ, . . . , Mₙ₊₁ₐ, . . . at the discharging, for example, in a practical SED in which the metalback M includes a more number of split portions M₁, M₂, . . . , Mₙ, . . . than the split portions shown in FIG. 4. The metalback M of the practical SED having a 36-inch display screen includes, for example, 256 split portions M₁ to M₂₅₆. It can be understood that the voltages are kept higher at the stripe portions farther from the stripe portion M_{nb} where the discharging occurs, i.e. the split portions farther from the split portion where the discharging occurs. A line linking the voltage values of the adjacent stripe portions is shaped in a waveform.

In the SED having the above structure, the limiting resistor 60 limits the supply of electric charges from the power supply unit 50 to the common electrode 30. When the discharging occurs at the stripe portion M_{2b}, the voltage of the common electrode drops, as the supply of electric charges to the common electrode 30 is limited. The potential difference between the common electrode and the stripe portion M_{2b} is thereby reduced. Thus, the discharging does not occur between the common electrode 30 and the stripe portion M_{2b}. In other words, the discharging for a long period can be restricted and, as a result, the damage caused by the discharging can be reduced.

The resistance value of the limiting resistor 60 is not limited to 10 kΩ. If the resistance value of the limiting resistor 60 falls within a range of 10 kΩ to 100 kΩ, the damage caused by the discharging can be reduced and high-brightness display can be implemented. In a case where the resistance value of the limiting resistor 60 is below 10 kΩ, as the supply of electric charges to the common electrode 30 can hardly be limited, the voltage of the common electrode hardly drops even at the time of discharging. In other words, extension of time of the discharging and expansion of the discharging are thereby caused.

In a case where the resistance value of the limiting resistor 60 is beyond 100 kΩ, the voltage of the common electrode 30 drops and the damage caused by the discharging is reduced, but the potential difference between the front substrate 1 and the back substrate 2 is reduced and the potential difference which allows the high-brightness display to be implemented cannot be obtained. For this reason, the brightness of the displayed images is degraded.

The split portions M₁ to M₄ include stripe portions M₁ₐ to M_{1c}, M₂ₐ to M_{2c}, M₃ₐ to M_{3c}, and M₄ₐ to M_{4c}, and each of the split portions is formed substantially in an S letter. The stripe portions of the adjacent split portions are alternately provided in the second direction d2. As the split portions M₁ to M₄ are formed as described above, when the discharging occurs, the voltage values become higher at the split portions farther from the split portion where the discharging occurs, and a line linking the voltage values of the adjacent stripe portions is shaped in a waveform. For this reason, expansion of the discharging can be restricted.

The present inventors studied the scale of discharging in a case where the metalback M is formed of a plurality of split portions that are merely formed in stripe shape. As a result of the study, when the discharging occurred, the discharging expanded to split portions adjacent to the split portion where it occurred, and the expansion of the discharging could not be restricted. However, it is not considered that the expansion of the discharging could not be restricted as the metalback M was in a stripe state, but merely the expansion of the discharging could not be restricted under the conditions at the study. Even when the metalback M is in a stripe state, the limiting resistor 60 is required by setting appropriate conditions such as changing the size of the metalback M, adding an appropriate resistance to the split portions, and the like.

Otherwise, when the split portions are merely formed in a stripe shape, each of the split portions is connected to the common electrode 30 via the connecting resistor electrically connected to both ends of the split portion. For this reason, a number of connecting resistors are connected in parallel to the common electrode 30. In a parallel circuit, the resistance value is lowered as more resisters are arranged in parallel. Therefore, when the discharging occurs at the split portions, the discharging causes significant drop of the voltage of the common electrode 30 and then the drop of voltages of the other split portions, and inconveniences such as increase in the discharged current, reduction in the brightness and the like occur in the displayed images.

With respect to this point, the number of first connecting resistors 21 and second connecting resistors 22 according to the first embodiment is significantly decreased and there is a certain resistance in the first connecting resistors and second connecting resistors. Therefore, significant drop of the voltage of the common electrode 30 can be restricted and a preferable display quality can be maintained.

The power supply unit 50 comprises the power supply 51 and the capacitance unit 52. Even if the capacitance of the capacitance unit 52 is increased due to small ripple, supply of the electric charges to the common electrode can be restricted by limiting resistor 60.

The high-voltage supply terminal 40 is spaced apart from the first electrode 31 and formed at the other end 33b of the third electrode 33. The electric connection distance between the high-voltage supply terminal 40 and the split portions M₁ to M₄ is longer by the third electrode 33 than the distance in a case where the high-voltage supply terminal or the other end 33b of the third electrode 33 is directly connected to the first electrode 31.

When the discharging occurs between the front substrate 1 and the back substrate 2, the potential difference is made between the common electrode 30 and the metalback M and the discharging occurs between the common electrode 30 and the metalback M. The discharging causes further discharging between the common electrode 30 and the back substrate 2, and the stripe-shaped damage is caused inside the vacuum envelope 4. At this time, the discharging which is to serve as a trigger occurs in the vicinity of the metalback M and the connecting resistors. This discharging occurs by the flow of a great amount of currents.

The current equivalent to 100A flows at the discharging between the front substrate 1 and the back substrate 2. In a steady state in which the discharging does not occur, the third electrode 33 becomes at low impedance. At the occurrence of the discharging, the impedance becomes high and the discharged current is decreased as the inductance performs. Thus, the discharging occurring in the vicinity of the metalback M and the connecting resistors can be restricted and the discharging between the common electrode 30 and the metalback M can be restricted.

When the discharged current flows, the potential difference is made between the high-voltage supply terminal 40 and the end of the first electrode 31 at the side of the high-voltage supply terminal and, therefore, an appropriate gap needs to be formed therebetween and the gap should preferably be greater.

As described above, the discharging occurring between the common electrode 30 and the metalback M can be restricted and the stripe-shaped damage can be restricted. For this reason, the breakage or deterioration of the electron emission elements 9 and the fluorescent surface 5 and the breakage of the driving circuit can be prevented. An SED of an excellent display quality can be thereby obtained.

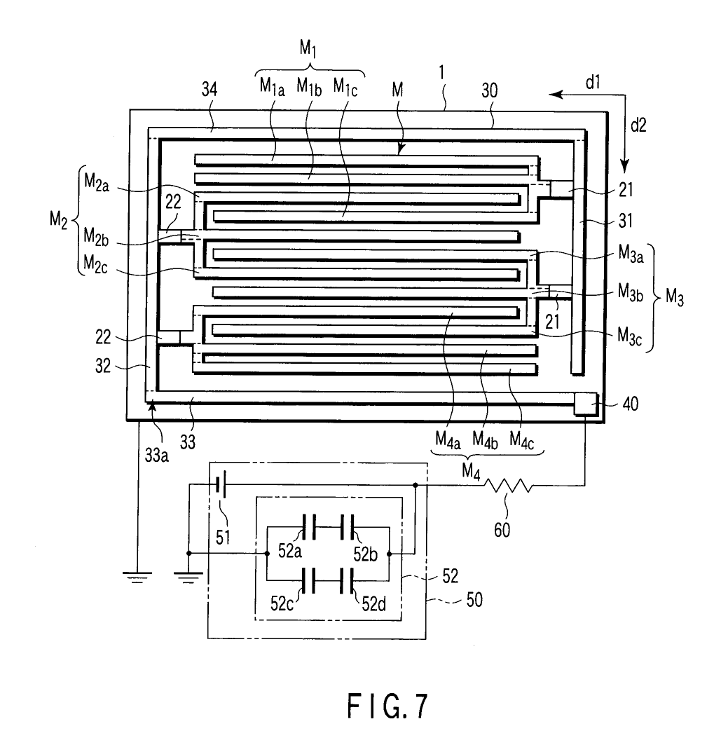

The present invention is not limited to the embodiment described above and can be modified in various manners without departing from the spirit and scope of the invention. For example, as shown in FIG. 7, the split portions M₁ to M₄ may be extended in the first direction d1, and arranged in the second direction d2 and spaced apart from each other, may include a plurality of stripe portions M₁ₐ to M_{1c}, M₂ₐ to M_{2c}, M₃ₐ to M_{3c} and M₄ₐ to M_{4c} that are electrically connected to each other, and may be arranged in the second direction. In this case, the stripe portions of the adjacent split portions may be provided alternately in the second direction d2. In other words, the shape of the split portions M₁ to M₄ is not limited to the S letter shape, but may be an E letter shape or any other shapes. Even when the split portions M₁ to M₄ are formed as described above, the same advantage as that of the above embodiment can be obtained.

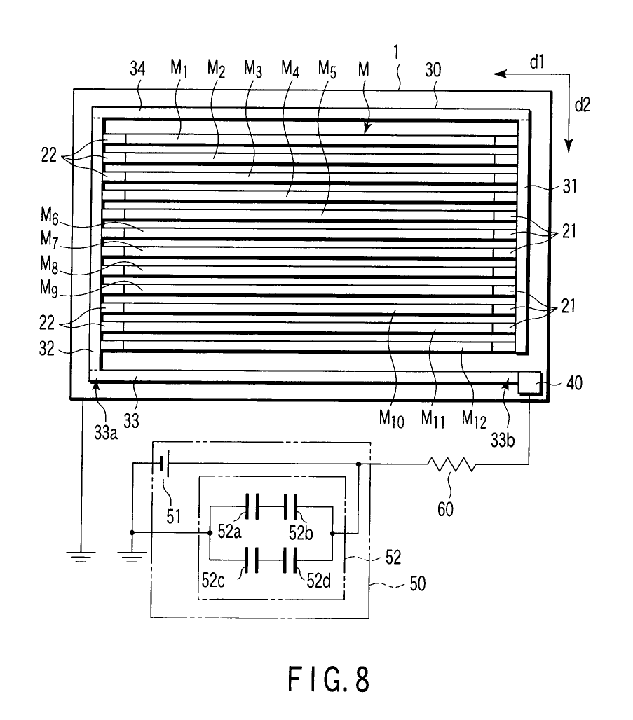

In addition, as shown in FIG. 8, the metalback M may comprise a plurality of split portions M₁ to M₁₂. The split portions M₁ to M₁₂ may be formed in a shape of stripes extending in the first direction d1, and arranged in the second direction d2 and spaced apart. Each of the split portions M₁ to M₁₂ is electrically connected to the common electrode 30 via the first connecting resistors 21 and the second connecting resistors 22 electrically connected to both ends of the split portion. Even when the split portions M₁ to M₁₂ are formed as described above, the supply of electric charges to the common electrode 30 is restricted by the limiting resistor 60 and, therefore, expansion of the discharging can be restricted.

The common electrode 30 is partially divided, but may not be divided but formed in a connected frame shape. The present invention is not limited to an SED, but can also be applied to an FED serving as an image display apparatus.

What is claimed is:

1. An image display apparatus, comprising:
a vacuum envelope including a front substrate in which a fluorescent surface is formed, and a back surface which is arranged opposite to the front substrate with a gap therebetween and in which a plurality of electron emission elements for exciting the fluorescent surface are provided, an interior of the vacuum envelope being kept vacuum;
a metalback including a plurality of split portions that superpose the fluorescent surface;
a plurality of connection resistors electrically connected to the split portions, respectively;
a common electrode arranged outside the metalback and electrically connected to the metalback via the connection resistors;
a power supply unit configured to supply electric charges to the common electrode; and
a limiting resistor connected between the common electrode and the power supply unit, to limit the supply of electric charges from the power supply unit to the common electrode.

2. The apparatus according to claim 1, wherein a resistance value of the limiting resistor is 10 kΩ to 100 kΩ.

3. The apparatus according to claim 1, wherein the plurality of split portions are extended in a first direction and arranged in a second direction orthogonal to the first direction and spaced apart from each other, and include stripe portions electrically connected to each other and arranged in the second direction, respectively, and
the stripe portions of the adjacent split portions are alternately provided in the second direction.

4. The apparatus according to claim 3, wherein each of the plurality of split portions is formed substantially in an S letter shape.

5. The apparatus according to claim 1, wherein the plurality of split portions are formed in a stripe shape extending in a first direction, and arranged in a second direction orthogonal to the first direction and spaced apart from each other.

6. The apparatus according to claim 1, further comprising a high-voltage supply terminal electrically connected between the connection resistors and the common electrode,
wherein the common electrode includes:
a pair of first and second electrodes provided opposite to each other outside the metalback, to sandwich the metalback in the first direction, extended in a second direction orthogonal to the first direction, and electrically connected to the plurality of split portions via the connecting resistors;
a third electrode extended in the first direction, outside the metalback, having one of ends electrically connected to the second electrode and the other end spaced apart from the first electrode; and
a fourth electrode provided opposite to the third electrode to sandwich the metalback in the second direction, extended in the first direction, and electrically connected to the first and second electrodes, and
the high-pressure supply terminal is formed at the other end of the third electrode.
